(19) United States
(12) Patent Application Publication
(10) Pub. No.: US 2008/0080955 A1
(43) Pub. Date: Apr. 3, 2008

(54) Cover for a lug nut of a wheel disk of a car

(76) Inventor: Yao-Huang Liu, Yung Kang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/520,245

(22) Filed: Sep. 13, 2006

(51) Int. Cl. F16B 37/14

(52) U.S. Cl. 411/429; 411/372.5

(57) ABSTRACT

A cover for a lug nut of a wheel disk of a car includes a cover body including a housing, a top cap mounted on the housing, and a screw extended through the housing and screwed into the top cap. Thus, the top cap is detachably mounted on the housing, so that the housing can fit top caps of different patterns to change the patterns of the cover body according to users' different requirements, thereby enhancing the versatility of the cover body. In addition, when the top cap or the housing is worn out, the user only needs to replace the top cap or the housing individually without having to replace the whole cover body, thereby greatly saving the costs.

### BACKGROUND OF THE INVENTION

1. Field of the Invention

The present invention relates to a cover and, more particularly, to a cover for a lug nut of a wheel disk of a car.

2. Description of the Related Art

A conventional cover 1 for a lug nut of a wheel disk of a car in accordance with the prior art shown in FIG. 11 is integrally formed by a plastic injection molding process. The cover 1 is mounted on the lug nut and has a top formed with a pattern to enhance the outer appearance of the lug nut. However, the cover only has a single pattern, so that the manufacturer has to produce covers of different patterns to fit users' requirements, thereby increasing costs of fabrication. In addition, when the cover is worn out during a long-term utilization, the user has to replace the whole cover, thereby greatly increasing the costs.

### BRIEF SUMMARY OF THE INVENTION

In accordance with the present invention, there is provided a cover, comprising a cover body including a housing, a top cap detachably mounted on the housing, and a screw extended through a top wall of the housing and screwed into the top cap to attach the top cap onto the housing.

The primary objective of the present invention is to provide a cover, wherein the cover body has a light emitting function, thereby greatly enhancing the aesthetic quality of the cover body.

Another objective of the present invention is to provide a cover, wherein the top cap is detachably mounted on the housing, so that the housing can fit top caps of different patterns to change the patterns of the cover body according to users' different requirements, thereby enhancing the versatility of the cover body.

A further objective of the present invention is to provide a cover, wherein when the top cap or the housing is worn out, the user only needs to replace the top cap or the housing individually without having to replace the whole cover body, thereby greatly saving the costs.

A further objective of the present invention is to provide a cover, wherein the cover body has different patterns or designs by changing different top caps, thereby decreasing costs of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially exploded perspective view of a cover in accordance with the preferred embodiment of the present invention.

FIG. 2 is an exploded perspective view of a cover body of the cover as shown in FIG. 1.

FIG. 3 is a plan cross-sectional assembly view of the cover body as shown in FIG. 2.

FIG. 4 is a plan cross-sectional assembly view of the cover as shown in FIG. 1.

FIG. 5 is a perspective view of a cover body of a cover in accordance with another preferred embodiment of the present invention.

FIG. 6 is a perspective view of a cover body of a cover in accordance with another preferred embodiment of the present invention.

FIG. 7 is an exploded perspective view of the cover body as shown in FIG. 6.

FIG. 8 is a plan cross-sectional view of the cover body as shown in FIG. 6.

FIG. 9 is a perspective view showing the cover body as shown in FIG. 6 being used for a wheel disk.

FIG. 10 is a perspective view showing the cover body as shown in FIG. 6 being used for a wheel disk.

FIG. 11 is a perspective view of a conventional cover in accordance with the prior art.

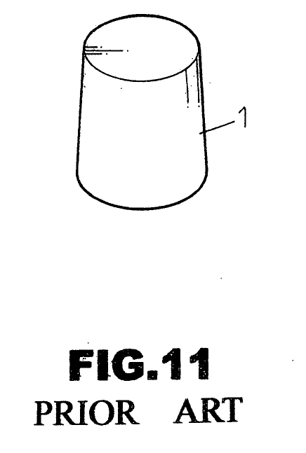

### DETAILED DESCRIPTION OF THE INVENTION

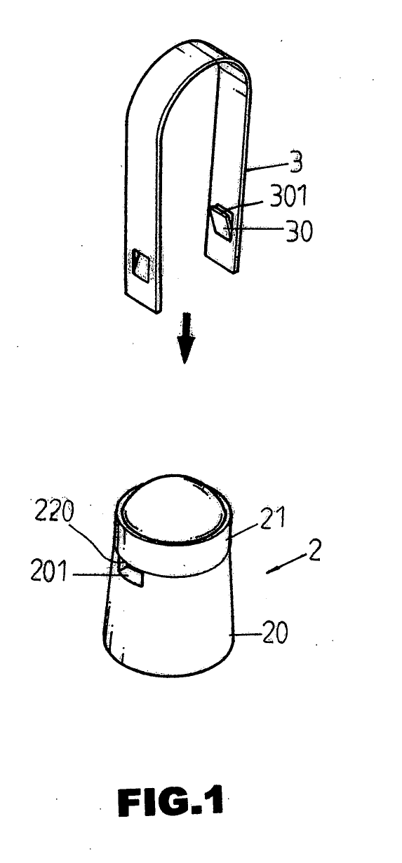

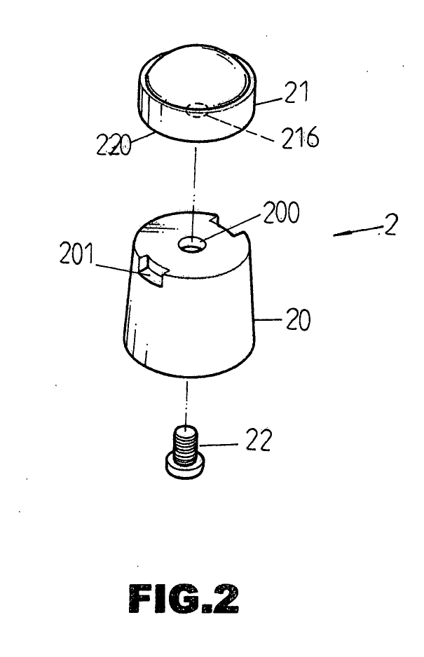

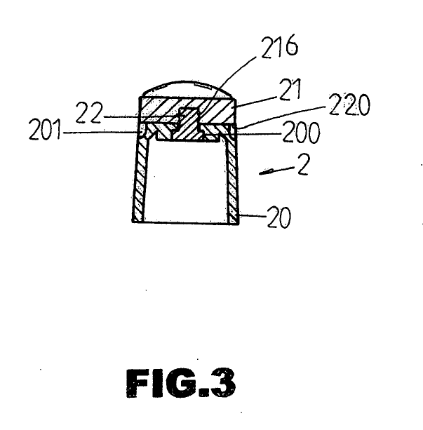

Referring to the drawings and initially to FIGS. 1-3, a cover in accordance with the preferred embodiment of the present invention comprises a cover body 2, and a clamping member 3 removably mounted on the cover body 2.

The cover body 2 includes a housing 20, a top cap 21 detachably mounted on the housing 20, and a screw 22 extended through a top wall of the housing 20 and screwed into the top cap 21 to attach the top cap 21 onto the housing 20.

The housing 20 is made of plastic or aluminum material and has a substantially cylindrical cross-sectional profile. The top wall of the housing 20 is formed with a through hole 200 to receive the screw 22. The housing 20 has a peripheral wall formed with two radially opposite locking grooves 201.

The top cap 21 has a circular shape and has a diameter corresponding to that of the housing 20. The top cap 21 has a pattern formed thereon to enhance the outer appearance of the cover body 2. The top cap 21 has a bottom face 220 rested on the top wall of the housing 20 to cover the locking grooves 201 of the housing 20 and is formed with a screw bore 216 into which the screw 22 is screwed.

The clamping member 3 is substantially inverted U-shaped and has two distal ends each provided with an inwardly extending locking hook 30 detachably locked in the respective locking groove 201 of the housing 20 to attach the clamping member 3 onto the housing 20 of the cover body 2. The locking hook 30 of the clamping member 3 has a top face 301 rested on the bottom face 220 of the top cap 21, so that the clamping member 3 is locked between the housing 20 and the top cap 21.

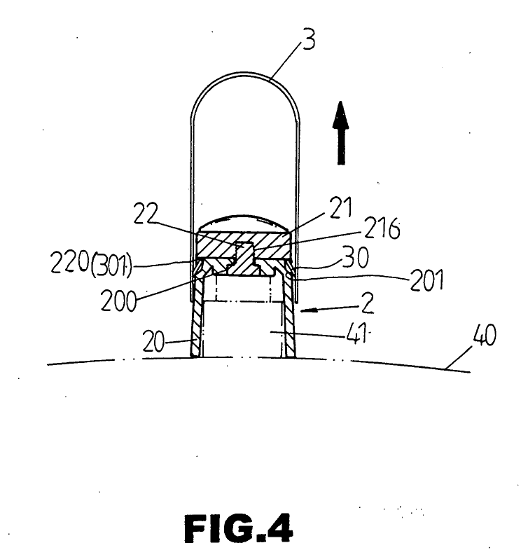

Referring to FIG. 4, the cover body 2 is mounted on a lug nut 41 of a wheel disk 40 of a wheel of a car to cover the lug nut 41 so as to enhance the outer appearance of the lug nut 41. When the clamping member 3 is mounted on the cover body 2, the locking hook 30 of the clamping member 3 is snapped into the respective locking groove 201 of the housing 20, and the top face 301 of the locking hook 30 of the clamping member 3 is rested on the bottom face 220 of the top cap 21, so that the clamping member 3 is locked between the housing 20 and the top cap 21 to lock the cover body 2. Thus, when the clamping member 3 is pulled outwardly, the cover body 2 is also pulled outwardly to detach from the lug nut 41.

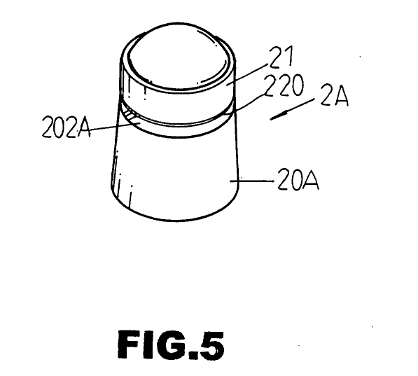

Referring to FIGS. 1 and 5, the housing 20A of the cover body 2A has a peripheral wall formed with an annular locking groove 202A, the clamping member 3 has two distal ends each provided with an inwardly extending locking hook 30 detachably locked in the locking groove 202A of the housing 20A to attach the clamping member 3 onto the housing 20A of the cover body 2A. The locking hook 30 of the clamping member 3 has a top face 301 rested on the bottom face 220 of the top cap 21, so that the clamping member 3 is locked between the housing 20A and the top cap 21.

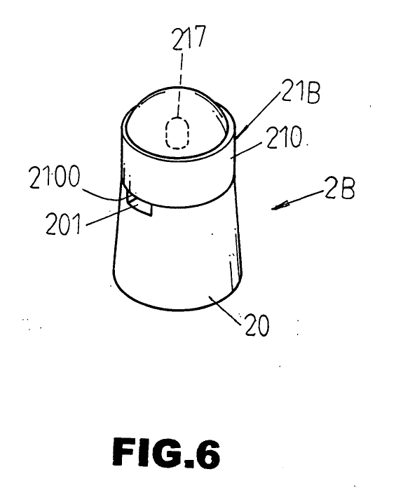

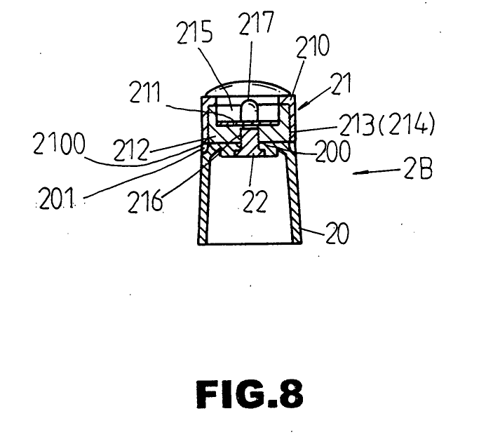

Referring to FIGS. 6-8, the top cap 21B of the cover body 2B includes a mounting member 212 having a bottom face 220 rested on the top wall of the housing 20, a circuit board 211 mounted in the mounting member 212, and a pattern member 210 mounted on the mounting member 212 to cover the mounting member 212 and the circuit board 211.

The mounting member 212 has an inside formed with a chamber 215 to receive the circuit board 211 and has an outer wall formed with an outer thread 214. The bottom face 220 of the mounting member 212 is formed with a screw bore 216 into which the screw 22 is screwed.

The circuit board 211 is provided with a light emitting diode (LED) 217, a battery 218 to supply an electric power to the light emitting diode 217, and a vibration type sensor 219 to control operation of the light emitting diode 217 by vibration.

The pattern member 210 has an inner wall formed with an inner thread 213 screwed onto the outer thread 214 of the mounting member 212, so that the mounting member 212 is encompassed by the pattern member 210 completely. The pattern member 210 has a bottom wall 2100 rested on the top wall of the housing 20 to cover the locking grooves 201 of the housing 20. The pattern member 210 has a circular shape and has a diameter corresponding to that of the housing 20. The pattern member 210 has a transparent top face formed with a pattern to enhance the outer appearance of the cover body 2B.

Referring to FIGS. 1 and 6-8, the clamping member 3 has two distal ends each provided with an inwardly extending locking hook 30 detachably locked in the respective locking groove 201 of the housing 20 to attach the clamping member 3 onto the housing 20 of the cover body 2. The locking hook 30 of the clamping member 3 has a top face 301 rested on the bottom wall 2100 of the pattern member 210, so that the clamping member 3 is locked between the housing 20 and the pattern member 210 of the top cap 21B.

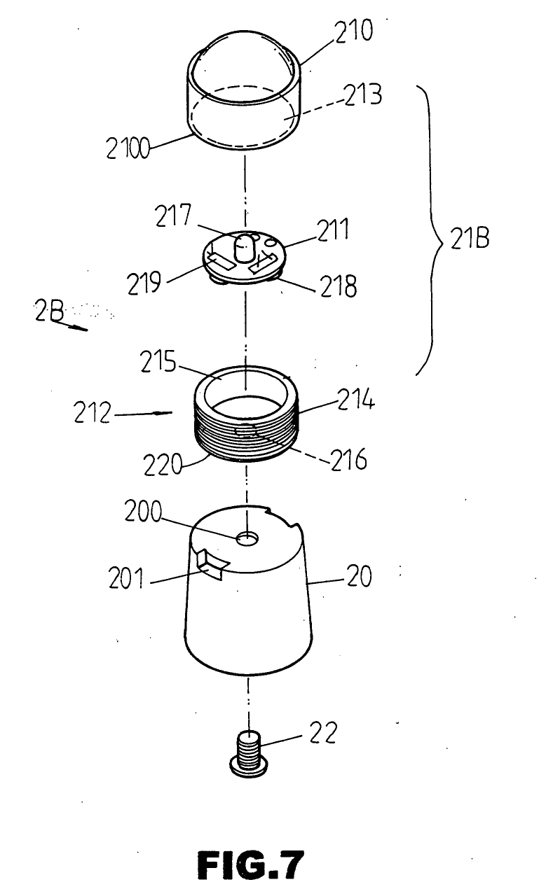

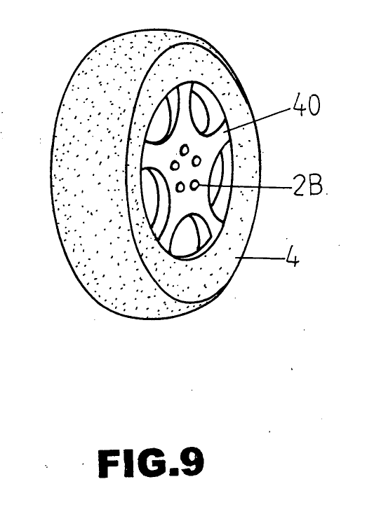

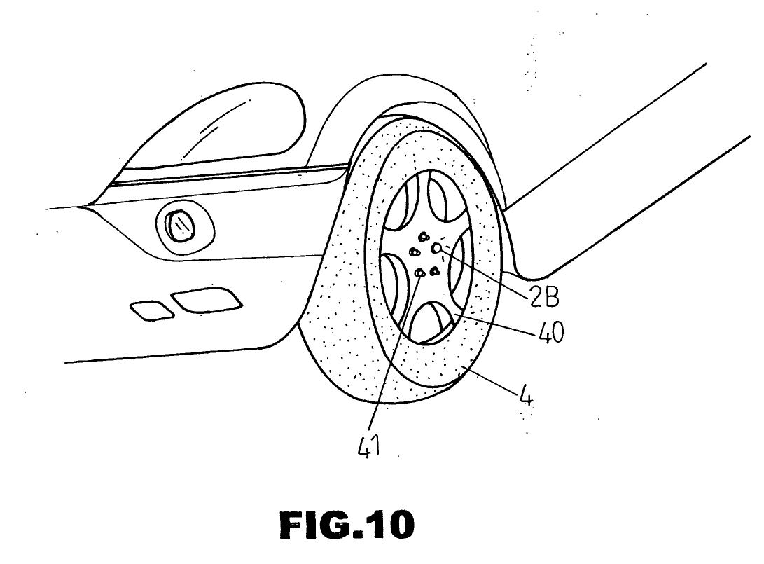

Referring to FIGS. 7, 9 and 10, the cover body 2B is mounted on a lug nut 41 of a wheel disk 40 of a wheel 4 of a car to cover the lug nut 41 so as to enhance the outer appearance of the lug nut 41. When the car is moving, the light emitting diode 217 is started by the sensor 219 due to vibration to emit light outwardly from the pattern member 210, thereby enhancing the aesthetic quality of the cover body 2B.

Accordingly, the cover body has a light emitting function, thereby greatly enhancing the aesthetic quality of the cover body. In addition, the top cap is detachably mounted on the housing, so that the housing can fit top caps of different patterns to change the patterns of the cover body according to users' different requirements, thereby enhancing the versatility of the cover body. Further, when the top cap or the housing is worn out, the user only needs to replace the top cap or the housing individually without having to replace the whole cover body, thereby greatly saving the costs. Further, the cover body has different patterns or designs by changing different top caps, thereby decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cover, comprising:
a cover body including a housing, a top cap detachably mounted on the housing, and a screw extended through a top wall of the housing and screwed into the top cap to attach the top cap onto the housing.

2. The cover in accordance with claim 1, wherein the top wall of the housing is formed with a through hole to receive the screw.

3. The cover in accordance with claim 1, wherein the top cap has a bottom face rested on the top wall of the housing.

4. The cover in accordance with claim 1, wherein the top cap is formed with a screw bore into which the screw is screwed.

5. The cover in accordance with claim 1, wherein the top cap of the cover body includes a mounting member having a bottom face rested on the top wall of the housing, a circuit board mounted in the mounting member, and a pattern member mounted on the mounting member to cover the mounting member and the circuit board.

6. The cover in accordance with claim 5, wherein the mounting member has an inside formed with a chamber to receive the circuit board.

7. The cover in accordance with claim 5, wherein the bottom face of the mounting member is formed with a screw bore into which the screw is screwed.

8. The cover in accordance with claim 5, wherein the circuit board is provided with a light emitting diode, a battery to supply an electric power to the light emitting diode, and a vibration type sensor to control operation of the light emitting diode by vibration.

9. The cover in accordance with claim 5, wherein the mounting member has an outer wall formed with an outer thread, and the pattern member has an inner wall formed with an inner thread screwed onto the outer thread of the mounting member, so that the mounting member is encompassed by the pattern member completely.

10. The cover in accordance with claim 3, further comprising a clamping member removably mounted on the cover body, wherein the housing has a peripheral wall formed with two radially opposite locking grooves, the bottom face of the top cap covers the locking grooves of the housing, the clamping member has two distal ends each provided with an inwardly extending locking hook detachably locked in the respective locking groove of the housing to attach the clamping member onto the housing of the cover body, and the locking hook of the clamping member has a top face rested on the bottom face of the top cap, so that the clamping member is locked between the housing and the top cap.

11. The cover in accordance with claim 3, further comprising a clamping member removably mounted on the cover body, wherein the housing of the cover body has a peripheral wall formed with an annular locking groove, the bottom face of the top cap covers the locking grooves of the housing, the clamping member has two distal ends each provided with an inwardly extending locking hook detachably locked in the locking groove of the housing to attach the clamping member onto the housing of the cover body, and the locking hook of the clamping member has a top face rested on the bottom face of the top cap, so that the clamping member is locked between the housing and the top cap.

12. The cover in accordance with claim 5, further comprising a clamping member removably mounted on the cover body, wherein the housing has a peripheral wall formed with two radially opposite locking grooves, the pattern member has a bottom wall rested on the top wall of the housing to cover the locking grooves of the housing, the clamping member has two distal ends each provided with an inwardly extending locking hook detachably locked in the respective locking groove of the housing to attach the clamping member onto the housing of the cover body, and the locking hook of the clamping member has a top face rested on the bottom wall of the pattern member, so that the clamping member is locked between the housing and the pattern member of the top cap.

13. The cover in accordance with claim 1, wherein the cover body is mounted on a lug nut of a wheel disk of a wheel.

14. The cover in accordance with claim 5, wherein the pattern member has a circular shape and has a diameter corresponding to that of the housing.

15. The cover in accordance with claim 5, wherein the pattern member has a transparent top face formed with a pattern.

16. The cover in accordance with claim 1, wherein the top cap has a circular shape.

17. The cover in accordance with claim 16, wherein the top cap has a diameter corresponding to that of the housing.

18. The cover in accordance with claim 1, wherein the top cap has a pattern formed thereon.

19. The cover in accordance with claim 1, wherein the housing has a substantially cylindrical cross-sectional profile.

20. The cover in accordance with claim 10, wherein the clamping member is substantially inverted U-shaped.
